(19) United States
(12) Patent Application Publication
(10) Pub. No.: US 2009/0088116 A1
(43) Pub. Date: Apr. 2, 2009

(54) METHOD AND APPARATUS OF SUCCESSIVE INTERFERENCE CANCELLATION FOR WIRELESS COMMUNICATION SYSTEM

(75) Inventors: Junyoung NAM, Daejeon (KR); Seong Rag KIM, Daejeon (KR); Hyun Kyu CHUNG, Daejeon (KR)

Correspondence Address: CANTOR COLBURN, LLP, 20 Church Street, 22nd Floor, Hartford, CT, 06103, US

(73) Assignee: Electronics and Telecommunications Research Institute, Daejeon (KR)

(21) Appl. No.: 12/240,298

(22) Filed: Sep. 29, 2008

(30) Foreign Application Priority Data
Sep. 28, 2007 (KR) 10-2007-0098174
Dec. 10, 2007 (KR) 10-2007-0127382

(51) Int. Cl. H04B 1/10

(52) U.S. Cl. 455/296

(57) ABSTRACT

A method and apparatus of successive interference cancellation for a wireless communication system is provided. A method of detecting a transmission signal for the method of the successive interference cancellation, the method including: receiving transmission signals transmitted from ‘M’ antennas; calculating a residual error value of each of the received transmission signals; and determining a detection sequence of the transmission signals based on the calculated residual error value.

### CROSS-REFERENCE TO RELATED APPLICATION

This application claims the benefit of Korean Patent Application Nos. 10-2007-0098174, filed on Sep. 28, 2007, and 10-2007-0127382, filed on Dec. 10, 2007 in the Korean Intellectual Property Office, the disclosure of which is incorporated herein by reference.

### BACKGROUND OF THE INVENTION

1. Field of the Invention

The present invention relates to successive interference cancellation of a wireless communication system for performing a Multiple-Input Multiple-Output (MIMO) scheme, and more particularly, to a method and apparatus of successive interference cancellation which can determine a detection sequence of receiving data steams in advance and cancel successive interferences based on the determined detection sequence.

This work was supported by the IT R&D program of MIC/IITA [2006-S-001-02, Development of Adaptive Radio Access and Transmission Technologies for 4th Generation Mobile Communications].

2. Description of Related Art

Generally, a wireless channel environment shows low reliability due to multi-path interference, shadowing, wave interference, non-stationary noise, interference, and the like.

Many schemes for solving a low-reliability problem of the wireless channel environment have been developed.

In particular, a Multiple-Input Multiple-Output (MIMO) system for separating multi-path signals by using different fading information enables diversity to be acquired by independent fading signals using a plurality of antennas in at least one of a transmitter and a receiver.

In the above-described MIMO system, ‘Vertical-Bell Labs Layered Space Time (V-BLAST)’ represents a conventional art for acquiring high frequency efficiency.

The V-BLAST repeats a process of first detecting a data symbol sent via a channel having a favorable channel state, and detecting the data symbol again after canceling an effect of the detected symbol as described above.

However, since a calculation amount for detecting a data stream is very large, O(M⁴) (M denotes a number of transmission antennas), the V-BLAST has a problem that complexity of a system increases.

Also, a method using a QR decomposition and a square-root algorithm is disclosed for solving the problem of the above-described V-BLAST scheme. This reduces the complexity of the system by reducing the calculation amount for detecting the data stream to be O(M³) using the QR decomposition and the square-root algorithm.

Also, much research for acquiring the high frequency efficiency in the MIMO system is under way, however, a method for successive interference cancellation appropriate for an actual wireless channel environment is not disclosed.

### SUMMARY OF THE INVENTION

The present invention provides a method and apparatus of successive interference cancellation which can reduce, using a Cholesky decomposition, complexity of a Vertical-Bell Labs Layered Space Time (V-BLAST) detector by half or less, compared with complexity according to a conventional art. The present invention reduces the complexity of the V-BLAST detector from O(M⁴) to O(M³), however, a number of actual transmission antennas is limited. In this case, complexity improvement may correspond to an effect of reducing the complexity twice.

The present invention also provides a method of determining a detection sequence of a transmission symbol vector which can reduce complexity of a V-BLAST detector.

The present invention also provides a method of determining an equalization coefficient which can reduce complexity of a V-BLAST detector.

According to an aspect of the present invention, there is provided a method of determining a signal detection sequence of a multi-antenna system, the method including: receiving transmission signals transmitted from ‘M’ antennas; calculating a residual error value of each of the received transmission signals; and determining a detection sequence of the transmission signals based on the calculated residual error value.

According to another aspect of the present invention, there is provided a method of determining an equalization coefficient of a multi-antenna system, the method including: decomposing an error covariance matrix of an i-th transmission signal of ‘M’ transmission signals via a Cholesky algorithm; calculating a nulling vector via a Cholesky factor of the decomposed error covariance matrix; and determining the equalization coefficient of the i-th transmission signal by using the calculated nulling vector.

According to still another aspect of the present invention, there is provided a method for successive interference cancellation, the method including: receiving transmission signals transmitted from ‘M’ antennas; determining a detection sequence of the transmission signals based on residual error values of the received transmission signals; selecting a first transmission signal based on the determined detection sequence and calculating a nulling vector of the first transmission signal via a Cholesky algorithm; and canceling, from a received signal, an interference of another transmission signal other than the first transmission signal by using the calculated nulling vector.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 illustrates an overview of a Multiple-Input Multiple-Output (MIMO) system according to an exemplary embodiment of the present invention;

FIG. 2 illustrates a configuration of an apparatus for successive interference cancellation according to an exemplary embodiment of the present invention;

FIG. 3 is a flowchart illustrating a method of determining a signal detection sequence of a multi-antenna system according to an exemplary embodiment of the present invention; and

FIG. 4 is a flowchart illustrating a method of determining a Minimum Mean Square Error (MMSE) filter coefficient according to an exemplary embodiment of the present invention.

### DETAILED DESCRIPTION OF EXEMPLARY EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

When detailed descriptions related to a well-known related function or configuration are determined to make the spirits of the present invention ambiguous, the detailed descriptions will be omitted herein. Also, terms used throughout the present specification are used to appropriately describe exemplary embodiments of the present invention, and thus may be different depending upon a user and an operator's intention, or practices of application fields of the present invention. Therefore, the terms must be defined based on descriptions made through the present invention.

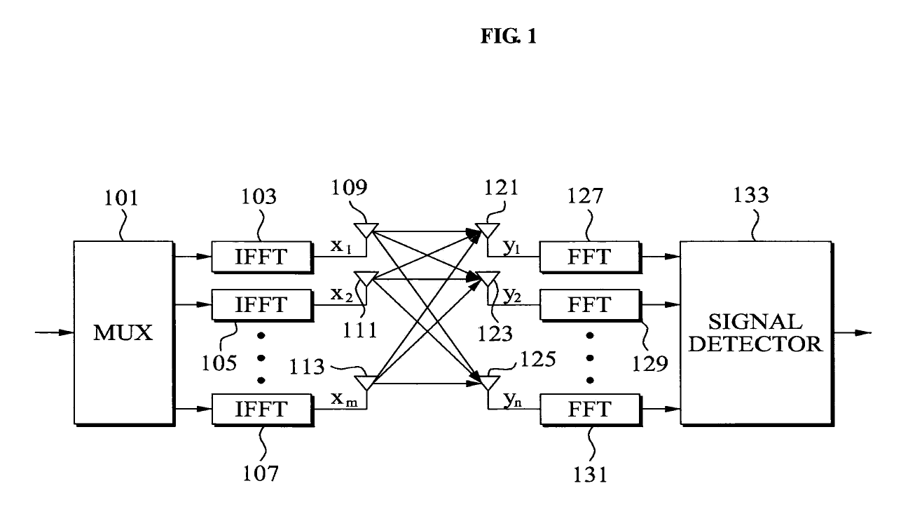

FIG. 1 illustrates an overview of a Multiple-Input Multiple-Output (MIMO) system according to an exemplary embodiment of the present invention.

As illustrated in FIG. 1, a transmitter includes a multiplexer (MUX) 101 and Inverse Fast Fourier Transformers (IFFTs) 103, 105, and 107 in a multi-antenna system including ‘M’ transmission antennas 109, 111, and 113, and ‘N’ receiving antennas 121, 123, and 125.

A receiver includes Fast Fourier Transformers (FFTs) 127, 129, and 131, and a signal detector 133.

First, in the transmitter, the MUX 101 performs multiplexing of data streams to be transmitted to the receiver at a number equal to a number of the transmission antennas 109, 111, and 113 and outputs the data streams. The IFFTs 103, 105, and 107 exist for each transmission antenna 109, 111, and 113, perform Inverse Fast Fourier Transforms (IFFTs) of an output signal of the MUX 101, and transmits the output signal via each transmission antenna 109, 111, and 113.

The receiver subsequently receives a signal from the transmitter for each antenna 121, 123, and 125, and the FFTs 127, 129, and 131 existing for each receiving antenna 121, 123, and 125 perform Fast Fourier Transforms (FFTs). The signal detector 133 performs a predetermined processing process of the data streams of which fast Fourier transforms are performed by the FFTs 127, 129, and 131.

In this instance, an N-dimensional received signal is in accordance with Equation 1:

y=Hx+n, [Equation 1]

where H=[h₁, h₂, . . . , h_{M}] denotes an N×M channel matrix, x=[x₁, x₂ . . . , x_{M}]^{T} denotes a transmission signal vector, and n denotes white Gaussian noise.

Also, an energy of a transmission signal vector denotes E[xx^{H}]=γI, and a Signal to Noise Ratio (SNR) per a receiving antenna denotes γ, where E[nn^{H}]=I.

Also, the received signal after canceling an interference caused by another i-th data stream of a method for successive interference cancellation of Vertical-Bell Labs Layered Space Time (V-BLAST) is in accordance with Equation 2 as follows. conjugate

$$\begin{matrix}{y}^{( i )} {=}^{Δ} y - {\sum }_{j = 1}^{i - 1} {h}_{{k}_{j}} {x}_{{k}_{j}} \\ = {\overline{H}}^{( i )} {\overline{x}}^{( i )} + n , 2 \leq i \leq M\end{matrix}$$

transpose function, and (−)^{H} denotes a

where x̅⁽ⁱ⁾=[xₖ_{ₘ}, xₖ_{_{M−1}}, . . . , xₖ_{ᵢ}]^{T} and y^{(M)}y.

A nulling vector of the signal from which the interference is canceled, similar to the above-described Equation 2, is in accordance with Equation 3:

W₍ᵢ₎=p₍ᵢ₎^{T}H₍ᵢ₎^{H}, [Equation 3]

where P₍ᵢ₎ denotes a column vector of P₍ᵢ₎ [symbol] (H₍ᵢ₎^{H}H₍ᵢ₎+γ⁻¹I_{M-1+1})⁻¹, and P₍ᵢ₎ [symbol] (H₍ᵢ₎^{H}H₍ᵢ₎+γ⁻¹I_{M-i+1})⁻¹ denotes an i-th reduced error covariance according to the method for the V-BLAST successive interference cancellation.

The above-described Equation 3 may be an equalization coefficient for Minimum Mean Square Error (MMSE) filtering.

In the V-BLAST method, a method of determining a transmission signal index for determining a detection sequence of ‘M’ transmission signals is in accordance with Equation 4:

kᵢ=argmin_{kε{1, . . . , M-i+1}}(P⁽ⁱ⁾)_{[k,k].}

where A_{[i,j]} denotes an ij element of matrix A.

Referring to the above-described Equation 4, the V-BLAST first detects a signal having the least estimation error distribution, that is, a signal having the least error probability, from every sequence. As described above, the detection scheme has a disadvantage of having a large calculation amount.

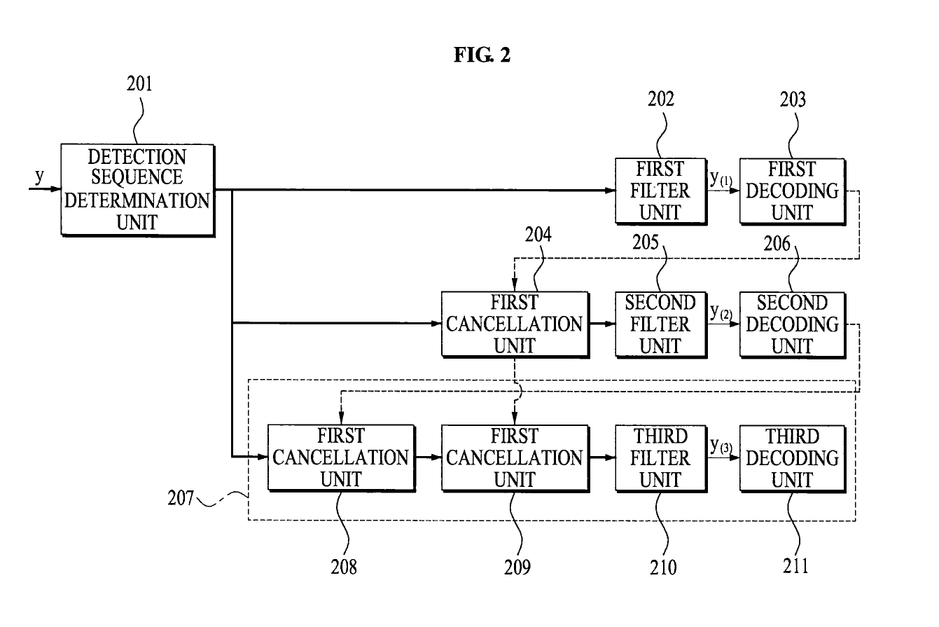

FIG. 2 illustrates a configuration of an apparatus for successive interference cancellation according to an exemplary embodiment of the present invention.

Referring to FIG. 2, the apparatus for the successive interference cancellation includes a detection sequence determination unit 201 to determine a detection sequence of transmission signals transmitted from ‘M’ antennas based on residual error values, a first filter unit 202 to cancel, from a received signal y, an interference of another transmission signal other than the transmission signal x₁ using a first filter coefficient w₁ for the transmission signal x₁ corresponding to the determined detection sequence, a first decoding unit 203 to decode a received signal y₁ from which the interference of the other transmission signal other than the transmission signal x₁ is canceled, a first cancellation unit 204 to cancel the transmission signal x₁ from the received signal y using the decoded signal, a second filter unit 205 to cancel, from the received signal from which the transmission signal x₁ is canceled, an interference of still another transmission signal other than a transmission signal x₂ using a second filter coefficient w₂ corresponding to the transmission signal x₂ corresponding to a next detection sequence, and a second decoding unit 206 to decode a received signal y₂ from which the interference of the still other transmission signal other than the transmission signal x₂ is canceled.

When a number ‘M’ of transmitter antennas is greater than or equal to three, the apparatus for the successive interference cancellation further includes a third decoding block 207 to cancel x₁ and x₂ from the received signal y, and detect another transmission signal other than x₁ and x₂.

In this instance, the third decoding block 207 includes a second cancellation unit 208, a first cancellation unit 209, a third filter unit 210, and a third decoding unit 211. Since each of these 207 to 211 performs a function identical to the first cancellation unit 204, the second filter unit 210, and the second decoding unit 206, a detailed description thereof is omitted.

As described above, the apparatus for the successive interference cancellation according to the present exemplary embodiment of the present invention may have different detection sequences of the transmission signals and different equalization coefficients, that is, NMSE filter coefficients for interference cancellation, compared with the V-BLAST method.

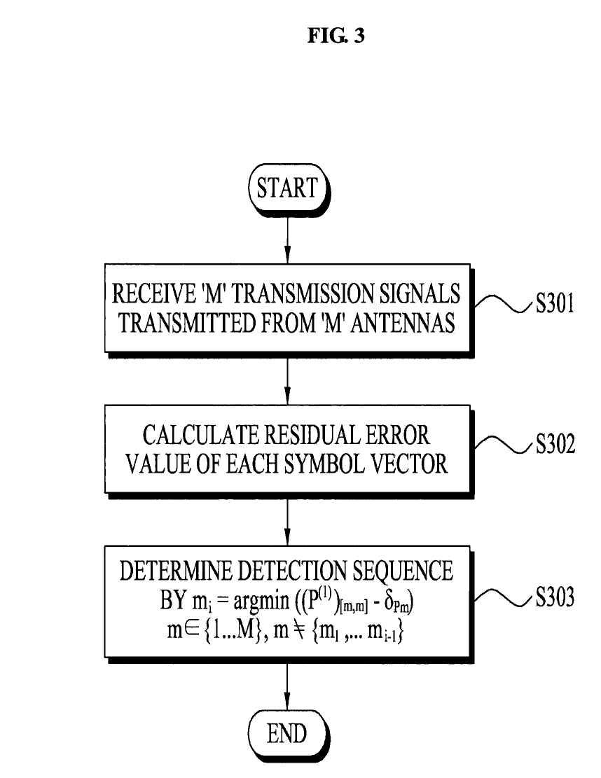

The detection sequence determination unit 201 determines a detection sequence of transmission symbol vectors according to a method illustrated in FIG. 3.

FIG. 3 is a flowchart illustrating a method of determining a signal detection sequence of a multi-antenna system according to an exemplary embodiment of the present invention.

Referring to FIG. 3, the method of determining the signal detection sequence includes operation S301 of receiving ‘M’ transmission signals transmitted from ‘M’ antennas, operation S302 of calculating a residual error value of each symbol vector of the received transmission signals, and operation S303 of determining a detection sequence of the transmission signals based on the calculated residual error value.

Specifically, a method of detecting a transmission signal according to the present exemplary embodiment of the present invention is in accordance with Equation 5:

mᵢ=argmin_{mε{1, . . . , M},m≠{m}_{₁}, . . . , m_{_{i−1}}_{}}((P⁽¹⁾)_{[m,m]}^{-δ}pₘ), [Equation 5]

where δ denotes a weighting factor that may be arbitrarily selected. Also, pₘ is in accordance with Equation 6 by performing an estimation error covariance of a transmission signal xₘ when an interference of another signal xⱼ, j≠i is perfectly canceled.

(hᵢ^{H}hᵢ+γ⁻¹)⁻¹ [symbol] pᵢ, [Equation 6]

where an estimation error pₘ denotes an error covariance of an MMSE estimation value of xₘ which may be irreducible after all other interferences are perfectly canceled. Accordingly, when a signal having a large irreducible estimation error may be canceled without an error at a beginning of the successive interference cancellation, residual signals have relatively small irreducible estimation errors. Therefore, a sum of estimation error covariances of all signals may be reduced. Accordingly, the above-described Equation 5 performs a function of reducing a receiving bit error rate by reducing a sum of estimation errors of all signals since the signal having the large irreducible estimation error is canceled from a possible preceding sequence based on the weighting factor.

Referring to the above-described Equation 5, the present exemplary embodiment of the present invention may determine the detection sequence of all ‘M’ transmission signals in advance, different from the V-BLAST of separately determining the sequence for each sequence.

Also, the above-described Equation 5 may reduce a calculation amount as described as follows since a performance similar to a conventional V-BLAST array scheme of the above-described Equation 4 is shown and the detection sequence is determined in advance.

A difference between the present invention and the V-BLAST may be understood using an example as follows.

For example, it is assumed that M=2, P_{[1,1]}⁽¹⁾=2.0, P_{[2,2]}⁽¹⁾=2.1, p₁=0.5, and p₂=1.0.

In the above-described example, the V-BLAST scheme may select x₁ as the transmission signal to be first detected by using the above-described Equation 4 even though an error covariance of x₂ is minimum from among the entire sequence. However, when δ is 1, x₂ may be determined as the first-detected signal by using the above-described Equation 5 according to the present exemplary embodiments of the present invention.

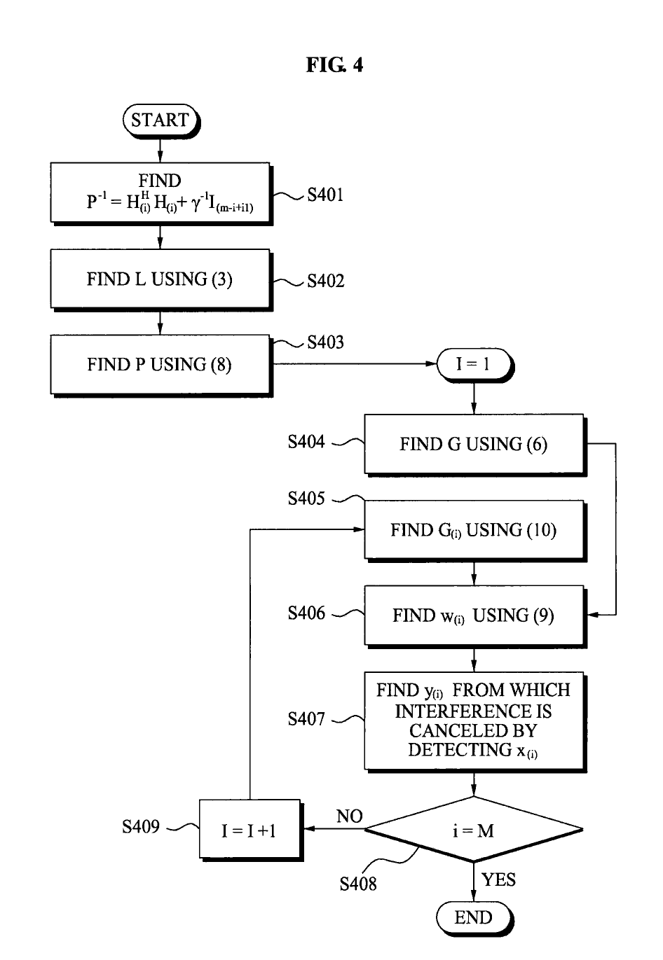

The filter units 202, 205, and 210 may calculate the MMSE filter coefficient using the method illustrated in FIG. 4.

FIG. 4 is a flowchart illustrating a method of determining an MMSE filter coefficient according to an exemplary embodiment of the present invention.

Referring to FIG. 4, the method includes operations S401 to S403 of decomposing an error covariance matrix of an i-th transmission signal of ‘M’ transmission signals via a Cholesky algorithm, operations S404 and S405 of calculating a nulling vector via a Cholesky factor of the decomposed error covariance matrix, and operation S406 of determining an equalization coefficient of the i-th transmission signal by using the calculated nulling vector. In FIG. 4, operations S407, S408, and S409 are processes for performing operations S405 and S406 for each of the ‘M’ transmission signals.

The filter units 202, 205, and 210 determine the MMSE filter coefficient using a Cholesky decomposition described as follows.

First, the Cholesky decomposition of the error covariance matrix may be performed in accordance with Equation 7:

P=GG^{H}, [Equation 7]

where G denotes a Cholesky factor of P as a unique lower triangular matrix having a positive diagonal element.

Also, a Cholesky decomposition of P⁻¹ is in accordance with Equation 8:

P⁻¹=LL^{H}, [Equation 8]

where L denotes a Cholesky factor of P⁻¹.

An inverse of two members in the above-described Equation 8 is in accordance with Equation 9:

P=UU^{H}, [Equation 9]

where U denotes an upper triangular matrix by a UL decomposition.

Accordingly, the MMSE filter coefficient using the above-described Equation 7 is in accordance with Equation 10:

W₍ᵢ₎=g₍ᵢ₎g₍ᵢ₎^{H}H₍ᵢ₎^{H}, [Equation 10]

where P₍ᵢ₎^{T}=g₍ᵢ₎g₍ᵢ₎^{H}, g₍ᵢ₎=(G₍ᵢ₎)_{[1,1]}, and g₍ᵢ₎=(G₍ᵢ₎)_{[:,i]}.

In this instance, the Cholesky factor G is in accordance with Equation 11:

G₍ᵢ₎=(G₁₎)_{[i:M,i:M]i,i=}1, 2, . . . , M. [Equation 11]

The MMSE filter coefficient may be calculated using the above-described Equation 10 and the above-described Equation 11.

Accordingly, the method of calculating the filter coefficient may reduce complexity, compared with a conventional art.

For reference, the above-described Equation 11 may be verified by the Cholesky algorithm.

Referring to FIG. 4, the present exemplary embodiment of the present invention finds the MMSE filter coefficient using the above-described Equation 3 through Equation 11, and detects the transmission signal based on the detection sequence.

As described above, the successive interference cancellation according to the present exemplary embodiment of the present invention may be summarized as follows.

First, the detection sequence determination unit 201 determines a detection sequence of transmission signals based on residual error values of the received transmission signals.

The first filter unit 202 subsequently selects a first transmission signal based on the determined detection sequence and calculates a nulling vector w₍ᵢ₎=g₍ᵢ₎g₍ᵢ₎^{H}H₍ᵢ₎^{H} of the first transmission signal via a Cholesky algorithm.

The first cancellation unit 204 cancels, from a received signal, an interference of another transmission signal other than the first transmission signal by using the calculated nulling vector.

According to the present invention, there is provided a method and apparatus of successive interference cancellation which can reduce, using a Cholesky decomposition, complexity of a V-BLAST detector by half or less, compared with complexity according to a conventional art.

Also, according to the present invention, there is provided a method of determining a detection sequence of a transmission symbol vector which can reduce complexity of a V-BLAST detector.

Also, according to the present invention, there is provided a method of determining an equalization coefficient which can reduce complexity of a V-BLAST detector.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of determining a signal detection sequence of a multi-antenna system, the method comprising:
receiving transmission signals transmitted from ‘M’ antennas;
calculating a residual error value of each of the received transmission signals; and
determining a detection sequence of the transmission signals based on the calculated residual error value.

2. The method of claim 1, wherein the residual error value is determined by an estimation error covariance and an arbitrary weighting factor.

3. The method of claim 1, wherein the determining determines the detection sequence based on a sequence ranging from a transmission signal having a small residual error value to a transmission signal having a large residual error value.

4. A method of determining an equalization coefficient of a multi-antenna system, the method comprising:
decomposing an error covariance matrix of an i-th transmission signal of ‘M’ transmission signals via a Cholesky algorithm;
calculating a nulling vector via a Cholesky factor of the decomposed error covariance matrix; and
determining the equalization coefficient of the i-th transmission signal by using the calculated nulling vector.

5. The method of claim 4, wherein the Cholesky factor is a unique lower triangular matrix having a positive diagonal element.

6. The method of claim 4, wherein the nulling vector is calculated by an element of a first row and a first column of the Cholesky factor, and a conjugate complex function of the first row of the Cholesky factor.

7. The method of claim 4, wherein the i-th transmission signal is detected based on a sequence ranging from a transmission signal of the ‘M’ transmission signals, the transmission signal having a small residual error value, to a transmission signal of the ‘M’ transmission signals, the transmission signal having a large residual error value.

8. A method for successive interference cancellation, the method comprising:
receiving transmission signals transmitted from ‘M’ antennas;
determining a detection sequence of the transmission signals based on residual error values of the received transmission signals;
selecting a first transmission signal based on the determined detection sequence and calculating a nulling vector of the first transmission signal via a Cholesky algorithm; and
canceling, from a received signal, an interference of another transmission signal other than the first transmission signal by using the calculated nulling vector.

9. The method of claim 8, further comprising:
decoding the received signal from which the interference is canceled, and canceling the interference due to the first transmission signal from the received signal by using the decoded signal.

10. The method of claim 8, wherein the determining calculates a residual error value of each of the transmission signals, and detects the transmission signals based on a sequence ranging from a transmission signal having a small residual error value to a transmission signal having a large residual error value.

11. The method of claim 8, wherein the nulling vector is calculated by an element of a first row and a first column of the Cholesky factor, and a conjugate complex function of the first row of the Cholesky factor.
